(19) United States
(12) Patent Application Publication
(10) Pub. No.: US 2015/0313103 A1
(43) Pub. Date: Nov. 5, 2015

(54) HYDROPONICS APPARATUS AND HYDROPONICS METHOD

(71) Applicant: PANASONIC INTELLECTUAL PROPERTY MANAGEMENT CO., LTD., Osaka-shi, Osaka (JP)

(72) Inventor: Hiroshi YANO, Osaka (JP)

(73) Assignee: PANASONIC INTELLECTUAL PROPERTY MANAGEMENT CO., LTD., Osaka (JP)

(21) Appl. No.: 14/653,390

(22) PCT Filed: Oct. 15, 2013
(86) PCT No.: PCT/JP2013/006127

§ 371 Date: Jun. 18, 2015

(30) Foreign Application Priority Data
Feb. 6, 2013 (JP) 2013-021261

(51) Int. Cl. A01G 31/02; A01G 1/00

(52) U.S. Cl. CPC A01G 31/02; A01G 1/001

(57) ABSTRACT

Provided is a hydroponics apparatus configured to grow a plant body having a taproot and lateral roots. The hydroponics apparatus includes: a supporting portion configured to support the plant body; a taproot feeding portion configured to feed the taproot by spraying a liquid onto the taproot; a lateral root feeding portion configured to feed the lateral roots by soaking the lateral roots in the liquid; and a controller configured to adjust at least one of a cycle and a length of time of spray by the taproot feeding portion. In the hydroponics apparatus, the controller limits an amount of liquid sprayed onto the taproot to an amount needed for the taproot.

### TECHNICAL FIELD

The present invention relates to a hydroponics apparatus for, and a hydroponics method of, growing a plant body.

### BACKGROUND ART

Among known hydroponics methods of growing root vegetables is what is described in PTL1 given below. PTL 1 describes that a root vegetable is grown with a tip end portion of a taproot soaked in a hydroponic nutrient solution, but with portions of the taproot other than the tip end portion not soaked in the hydroponic nutrient solution.

The hydroponics method described in PTL1, however, involves likelihood of feeding the taproot too much or too less.

The present invention has been made with the foregoing situation taken into consideration. An object of the present invention is to provide a hydroponics apparatus and a hydroponics method which are capable of supplying an appropriate amount of liquid to a plant body.

### CITATION LIST

### Patent Literature

[PTL 1] Japanese Patent Application Publication No. 2005-91

### SUMMARY OF INVENTION

A hydroponics apparatus of a first aspect of the present invention is a hydroponics apparatus configured to grow a plant body having a taproot (a main root) and lateral roots (branch roots, secondary roots). The hydroponics apparatus is characterized by including: a supporting portion configured to support the plant body; a taproot feeding portion configured to feed the taproot by spraying a liquid onto the taproot; a lateral root feeding portion configured to feed the lateral roots by soaking the lateral roots in the liquid; and a controller configured to adjust at least one of a cycle and a length of time of spray by the taproot feeding portion. The hydroponics apparatus is characterized in that the controller limits an amount of liquid sprayed onto the taproot to an amount needed for the taproot.

A hydroponics apparatus of a second aspect of the present invention is the hydroponics apparatus of the first aspect, which is characterized in that the lateral root feeding portion feeds the lateral roots in a way that an amount of liquid supplied to the lateral roots by the lateral root feeding portion is larger than the amount of liquid supplied to the taproot by the taproot feeding portion.

A hydroponics apparatus of a third aspect of the present invention is the hydroponics apparatus of the first or second aspect, which is characterized in that: the lateral root feeding portion includes a water tank which locates a surface of the liquid supplied to the lateral roots under a lower end of the taproot; and the lateral roots extending from the taproot are soaked in the water tank.

A hydroponics apparatus of a fourth aspect of the present invention is the hydroponics apparatus of any one of the first to third aspects, which is characterized in that the liquid from the taproot feeding portion is supplied to only a desired part of the taproot.

A hydroponics apparatus of a fifth aspect of the present invention is the hydroponics apparatus of any one of the first to fourth aspects, which is characterized in that the lateral root feeding portion includes a circulator configured to circulate the liquid in which the lateral roots are soaked.

A hydroponics apparatus of a sixth aspect of the present invention is the hydroponics apparatus of any one of the first to fifth aspects, which is characterized in that the taproot feeding portion sprays mist with a mist particle diameter of 10 micrometers to 100 micrometers onto the taproot.

A hydroponics method of a seventh aspect of the present invention is a hydroponics method of growing a plant body having a taproot and lateral roots. The hydroponics method is characterized by including: feeding the taproot by spraying a liquid onto the taproot; and feeding the lateral roots by soaking the lateral roots in the liquid. The hydroponics method is characterized in that an amount of liquid sprayed onto the taproot is limited to an amount needed for the taproot.

### BRIEF DESCRIPTION OF DRAWINGS

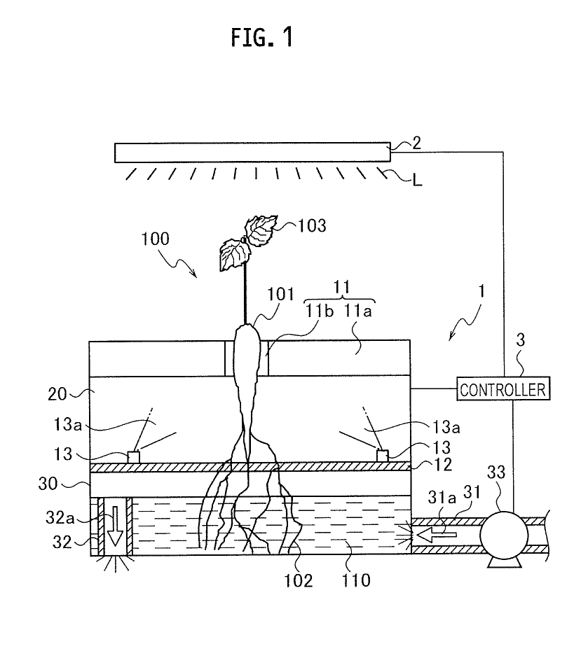

### [FIG. 1]

FIG. 1 is a cross-sectional view illustrating a configuration of a hydroponics apparatus shown as an embodiment of the present invention.

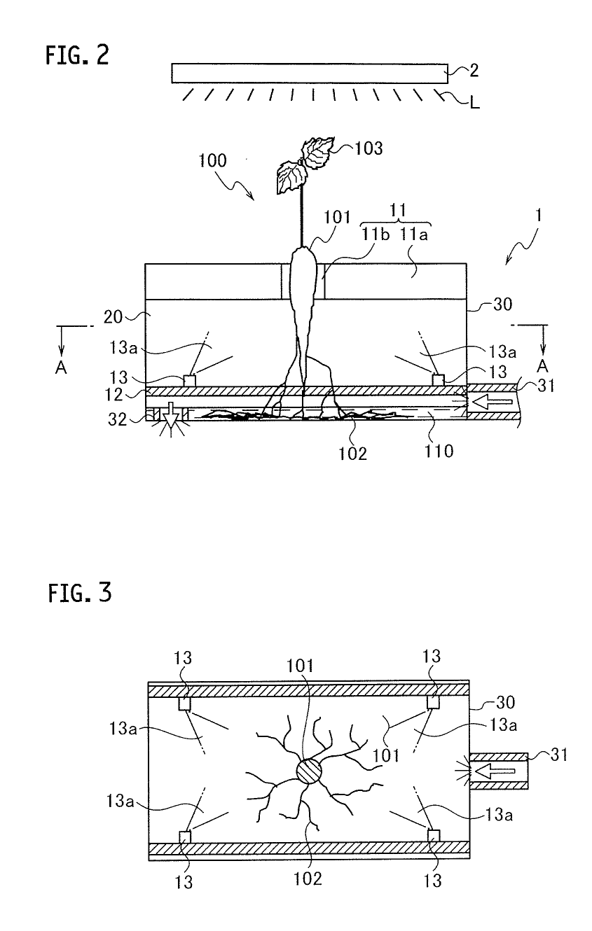

### [FIG. 2]

FIG. 2 is a cross-sectional view illustrating another configuration of the hydroponics apparatus shown as the embodiment of the present invention.

### [FIG. 3]

FIG. 3 is a cross-sectional view of the hydroponics apparatus shown as the embodiment of the present invention, taken along the A-A line of FIG. 2.

### DESCRIPTION OF EMBODIMENTS

Referring to the drawings, descriptions will be provided for an embodiment of the present invention.

A hydroponics apparatus 1 to which the present invention is applied is configured as shown in FIGS. 1 to 3, for example. The hydroponics apparatus 1 performs hydroponics in which a plant body 100 is grown by supplying a liquid to roots 101, 102 (underground portions) of the plant body 100 without using soil for the purpose of growing the plant body 100.

The following descriptions provided for the hydroponics apparatus 1 shown as the embodiment of the present invention is about a hydroponics apparatus configured to grow a root crop, for example. Nevertheless, the type of plant body 100 is arbitrary as long as the plant body 100 has the taproot 101 and the lateral roots 102. In addition, the liquid supplied to the plant body 100 in the embodiment, which will be described, includes water, and a hydroponic nutrient solution which is obtained by adding nutritious substances to water.

The hydroponics apparatus 1 illustrated in FIG. 1 grows the plant body 100 having the taproot 101 and the lateral roots 102. The hydroponics apparatus 1 includes: a supporting portion 11 (11a, 11b), a taproot feeding portion (12, 13), a lateral root feeding portion (30, 31, 32, 33), and a controller 3.

The supporting portion 11 supports the plant body 100. The supporting portion 11 includes a lid portion 11a and a penetrated portion 11b. The supporting portion 11 supports the taproot 101 of the plant body 100 from side portions. In the hydroponics apparatus 1 illustrated in FIG. 1, a column-shaped sponge having the penetrated portion 11b in a central position of the lid portion 11a, for example, maybe used as the supporting portion 11. Thereby, the supporting portion 11 supports the plant body 100 using frictional force between the sponge and the plant body 100.

It should be noted that it does not matter what the supporting portion 11 is made from, for example it does not matter that the supporting portion 11 is made from a string-like object for pulling the terrestrial part of the plant body 100, as long as the supporting portion 11 can support the plant body 100. Incidentally, the lid portion 11a may be provided with multiple penetrated portions 11b.

As for the plant body 100 supported by the supporting portion 11, the upper end of the taproot 101 is exposed from the lid portion 11a. The stalk and leaves 103 extend upward from the upper end of the taproot 101.

A light source 2 is provided above the hydroponics apparatus 1. The light source 2 is made from multiple LEDs, for example. The light source 2 enables the stalk and leaves 103 to perform photosynthesis by receiving light L emitted from the light source 2.

The taproot feeding portion sprays the liquid (mist) 13a onto the taproot 101 through a space 20 inside a water tank 30. Thereby, the taproot feeding portion feeds the taproot 101. The taproot feeding portion includes an attachment portion 12 and sprayers 13.

The attachment portion 12 is provided to the inner wall of the water tank 30. In the embodiment, as illustrated in FIG. 3, the attachment portion 12 is provided to the inner wall of the water tank 30 in a way that the attachment portion 12 is opposite the inner wall of the water tank 30. FIG. 3 illustrates the cross section of the hydroponics apparatus taken along the A-A line of FIG. 2. Incidentally, the example illustrated in FIG. 3 shows a configuration in which the liquid 13a is sprayed toward the center from the four corners of the water tank 30.

The attachment portion 12 may be provided at an arbitrary height position in the water tank 30 as long as the sprayers 13 can supply the liquid 13a to the taproot 101. One or multiple sprayers 13 are attached to the attachment portion 12. Incidentally, the attachment portion 12 may have a function of adjusting the height of the attachment portion 12 in the direction of height of the hydroponics apparatus 1 in a way that the surface of the liquid supplied to the lateral roots 102 is located under the lower end of the taproot 101.

Each sprayer 13 sprays the liquid 13a. The sprayer 13 is connected to a liquid supply pipe (not illustrated). The sprayer 13 sprays the liquid 13a (in mist), which is supplied through the liquid supply pipe, from its nozzle portion.

It is desirable that each sprayer 13 spray mist (13a) with a particle diameter of 10 micrometers to 100 micrometers onto the taproot 101. The reason for this is that the number of sprayers 13 intends to be reduced by supplying the liquid 13a evenly to the surface of the taproot 101.

As long as the diameter of the mist (13a) particles is not greater than 100 micrometers, the spray mode of the sprayers 13 may be arbitrary. Examples of the spay mode include an atomization type using a high-pressure gas, an ultrasonic mist type, and the like. It should be noted that the space 20 inside which the sprayers 13 spray the mist be close to hermetic for the purpose of enhancing the efficiency of mist feeding.

In addition, it is desirable that, as illustrated in FIG. 3, the sprayers 13 be capable of spraying the liquid 13a onto the taproot 101 in multiple directions. This makes it possible for the sprayers 13 to supply the liquid 13a to intended parts of the taproot 101.

Furthermore, the controller 3 adjusts at least one of a cycle and a length of time of spray of the liquid 13a by the sprayer 13. This makes it possible for the sprayer 13 to limit an amount of liquid 13a sprayed onto the taproot 101 to an amount needed for the taproot 101.

In other words, the feeding of the taproot 101 is reduced to a minimum requirement which has no influence on the growth of the plant body 100 from viewpoints of root hair growth inhibition and root rot prevention. The minimum requirement for the liquid 13a is included in predetermined growth conditions. The growth conditions include: the spray cycle in which each sprayer 13 sprays the mist; and the length of spray time for which the sprayer 13 sprays the mist in each spray cycle.

It should be noted that each sprayer 13 may limit an amount of nutrients supplied to the taproot 101 in addition to limiting the amount of spray of the liquid 13a.

For each sprayer 13, the controller 3 stores data on the cycle and the length of time of spray in a memory in advance. Thereby, the controller 3 judges whether the cycle of spray starts on time measured by a timer (not illustrated). Depending on this judgement, the controller 3 makes each sprayer 13 spray the mist for the predetermined length of time of spray.

Thereby, the controller 3 is capable of making each of one or more desired sprayers 13 supply the liquid 13a to the taproot 101 in the predetermined cycle of spray, and for the predetermined length of time of spray.

The lateral root feeding portion feeds the lateral roots 102 with the lateral roots 102 soaked in a liquid 100. The lateral root feeding portion includes the water tank 30, a liquid introducing passage 31, a liquid drain passage 32 and a circulation pump 33.

A liquid 31a is introduced into the water tank 30 from the liquid introducing passage 31. The water tank 30 stores a liquid 110 in a way that an amount of liquid 110 stored in the water tank 30 is larger than an amount of liquid 110 in which the lateral roots 102 extending from the taproot 101 are soaked. Furthermore, the amount of liquid 110 in the water tank 30 is adjusted in a way that the surface of the liquid used to feed the lateral roots 102 is located under the lower end of the taproot 101.

This adjustment inhibits, for example, root hair from beginning to grow, and the taproot 101 from getting rotten, due to the liquid 110 which would otherwise come into touch with the taproot 101.

The circulation pump 33, as a circulation unit, configured to circulate the liquid 110 in which the lateral roots 102 is soaked is connected to the liquid introducing passage 31. The number of revolutions of the circulation pump 33 is adjusted in accordance with the control by the controller 3. The adjustment of the number of revolutions of the circulation pump 33 makes it possible to adjust the amount of liquid 31a introduced into the water tank 30 from the liquid introducing passage 31, and the amount of liquid 32a drained from the liquid drain passage 32.

Thereby, the amount of liquid 110 circulated in the water tank 30 is adjusted. The amount of circulated liquid 110 is adjusted in a way that the amount is larger than the amount of liquid 13a supplied to the taproot 101 by the taproot feeding portion. Thus, the hydroponics apparatus 1 feeds the lateral roots 102 in a way that the amount of liquid supplied to the lateral roots 102 is larger than the amount of liquid supplied to the taproot 101.

It should be noted that the configuration configured to circulate the liquid 110 in the water tank 30 is not limited to the circulation pump 33, and may be a unit configured to tip the water tank 30, or the like instead.

Furthermore, as illustrated in FIG. 2, the lateral root feeding portion may have the configuration in which the surface of the liquid in the water tank 30 is located right under the lower end of the taproot 101. In the case where the lateral root feeding portion has the configuration as illustrated in FIG. 2, the lateral root feeding portion may perform a type of hydroponics in which the lateral root feeding portion makes the liquid 110 flow in a thin stream (in small amounts) down along a flat surface of a gentle inclination. This type of hydroponics is termed as nutrient film technique (NFT). The configuration as illustrated in FIG. 2 makes it possible to reduce the size of the hydroponics apparatus 1.

The cross section of the hydroponics apparatus 1 taken along the A-A line of FIG. 2 is as illustrated in FIG. 3. A reduction in the depth of the liquid 110 stored in the water tank 30 makes the lateral roots 102 expand in the horizontal direction. This makes it possible for the plant body 100 to grow more healthfully than when as illustrated in FIG. 1, the lateral roots 102 is hung vertically. This, however, inhibits the growth of the taproot 101 in the vertical direction.

The controller 3 is connected to the sprayers 13 and the circulation pump 33 in the hydroponics apparatus 1. The controller 3 is further connected to the light source 2. The controller 3, for example, may be a control device which is included in the hydroponics apparatus 1. Otherwise, the controller 3 may be a personal computer, portable terminal or similar thing of the user. In addition, the controller 3 may be connected to multiple hydroponics apparatuses 1 and multiple light sources 2, instead of the single hydroponics apparatus 1 and the single light source 2.

The controller 3 adjusts at least one of the cycle and the length of time of spray by the taproot feeding portion (12, 13). The controller 3 limits the amount of liquid 13a sprayed onto the taproot 101 to the amount needed for the taproot 101. For the purpose of realizing this, the cycle and the length of time of spray by the taproot feeding portion 13 are set in advance. In addition, it is desirable that one or more sprayers 13 to be driven for the purpose of supplying the liquid 13a to only a desired part of the taproot 101 be switchingly selected by the controller 3 from the multiple sprayers 13.

Moreover, the controller 3 performs control so that the amount of liquid supplied to the lateral roots 102 by the lateral root feeding portion (30, 31, 32, 33) may become larger than the amount of liquid supplied to the taproot 101 by the taproot feeding portion (12, 13). To this end, the controller 3 controls the number of revolutions of the circulation pump 33, and thereby adjusts flow rates at which the liquid passes through the liquid introducing passage 31, the water tank 30 and the liquid drain passage 32, respectively.

In addition, the controller 3 may control a cycle and a length of time of light emission from the light source 2.

As described above, the hydroponics apparatus 1 is capable of realizing the hydroponics method in which: the feeding of the taproot 101 is achieved by spraying the liquid 13a onto the taproot 101; and the feeding of the lateral roots 102 is achieved by soaking the lateral roots 102 in the liquid 110. While performing the hydroponics method, the hydroponics apparatus 1 is capable of limiting the amount of liquid 13a sprayed onto the taproot 101 to the amount needed for the taproot 101. Thereby, the hydroponics apparatus 1 is capable of supplying the appropriate amounts of liquids (13a, 110) to the plant body 100.

Thus, the hydroponics apparatus 1 grows the plant body 100 which is one of the so-called root vegetables without soaking the taproot 101 of the plant body 100 in any liquid. Thereby, the hydroponics apparatus 1 is capable of preventing much root hair from beginning to grow from the taproot 101; and avoiding a situation in which harvesting parts such as the taproot 101, adventitious roots, rhizomes (root stalks), tubers or the like do not grow sufficiently.

In this respect, a root vegetable having the taproot 101 and the lateral roots 102 absorbs water and nutrients via the lateral roots 102 and root hair growing from the lateral roots 102. For this reason, it is desirable that the feeding of the lateral roots 102 be supported by both a sufficient amount of water and a sufficient amount of nutrients in order to optimally grow the plant body 100. To this end, the hydroponics apparatus 1 is configured such that the lateral roots 102 are soaked in the liquid 110 in order to supply the sufficient amount of water and the sufficient amount of nutrients to the lateral roots 102.

On the other hand, if the taproot 101 is fed in the same manner as is the lateral roots 102, there is likelihood that the taproot 101 gets rotten because the amount of water is too much for the taproot 101. For this reason, the hydroponics apparatus 1 limits the amount of liquid supplied to the taproot 101. In addition, the hydroponics apparatus 1 supplies the lateral roots 102 with the more liquid than supplied to the taproot 101. Thereby, the hydroponics apparatus 1 is capable of feeding the lateral roots sufficiently while feeding the taproot 101 within the necessary minimum range.

Furthermore, since the taproot 101 is not soaked in the liquid 110, the hydroponics apparatus 1 needs no configuration for raising and lowering the surface of the liquid in the water tank 30. This makes the configuration of the hydroponics apparatus 1 compact and economical. Nevertheless, the hydroponics apparatus 1 is capable of inhibiting root hair from beginning to grow from the taproot 101, and facilitating the growth of the harvesting parts.

It should be noted that the foregoing embodiment is one example of the present invention. For this reason, the present invention is not limited to the foregoing embodiment. Various modifications may be made to the present invention depending on the design and the like within the scope not departing from the technical thoughts about the present invention, even if the modifications lead to other embodiments.

The entire contents of Japanese Patent Application No. 2013-021261 (filed on Feb. 6, 2013) are incorporated herein.

### INDUSTRIAL APPLICABILITY

The present invention can limit the amount of liquid sprayed onto the taproot to the amount needed for the taproot while soaking the lateral roots soaked in the liquid. Thereby, the present invention can supply the appropriate amount of liquid to the plant body.

### REFERENCE SIGNS LIST

1 hydroponics apparatus
3 controller
11 supporting portion
13 sprayer
30 water tank
31 liquid introducing passage
32 liquid drain passage
33 circulation pump
100 plant body
101 taproot
102 lateral roots

1. A hydroponics apparatus configured to grow a plant body having a taproot and lateral roots, comprising:
a supporting portion configured to support the plant body;
a taproot feeding portion configured to feed the taproot by spraying a liquid onto the taproot;
a lateral root feeding portion configured to feed the lateral roots by soaking the lateral roots in the liquid; and
a controller configured to adjust at least one of a cycle and a length of time of spray by the taproot feeding portion,
wherein the controller limits an amount of liquid sprayed onto the taproot to an amount needed for the taproot.

2. The hydroponics apparatus according to claim 1, wherein the lateral root feeding portion feeds the lateral roots in a way that an amount of liquid supplied to the lateral roots is larger than the amount of liquid supplied to the taproot by the taproot feeding portion.

3. The hydroponics apparatus according to claim 1, wherein
the lateral root feeding portion includes a water tank which locates a surface of the liquid supplied to the lateral roots under a lower end of the taproot, and
the lateral roots extending from the taproot are soaked in the water tank.

4. The hydroponics apparatus according to claim 1, wherein the liquid from the taproot feeding portion is supplied to only a desired part of the taproot.

5. The hydroponics apparatus according to claim 1, wherein the lateral root feeding portion includes a circulator configured to circulate the liquid in which the lateral roots are soaked.

6. The hydroponics apparatus according to claim 1, wherein the taproot feeding portion sprays mist with a particle diameter of 10 micrometers to 100 micrometers onto the taproot.

7. A hydroponics method of growing a plant body having a taproot and lateral roots, comprising:
feeding the taproot by spraying a liquid onto the taproot; and
feeding the lateral roots by soaking the lateral roots in the liquid,
wherein an amount of liquid sprayed onto the taproot is limited to an amount needed for the taproot.
